(19) United States
(12) Patent Application Publication
(10) Pub. No.: US 2025/0087751 A1
(43) Pub. Date: Mar. 13, 2025

(54) ELECTROLYTE COMPOSITIONS

(71) Applicant: Dyson Technology Limited, Wiltshire (GB)

(72) Inventors: Liyu JIN, Swindon (GB); Matthew Robert ROBERTS, Oxford (GB); Yu HU, Swindon (GB); Alex MADSEN, Swindon (GB); Qiaochu TANG, Oslo (CA); Daniel James MORDAK, Swindon (GB)

(21) Appl. No.: 18/292,591

(22) PCT Filed: Jul. 28, 2022
(86) PCT No.: PCT/GB2022/051996

§ 371 Date: Jan. 26, 2024

(30) Foreign Application Priority Data
Aug. 4, 2021 (GB) 2111249.5

(51) Int. Cl. H01M 10/0568; H01M 10/0567; H01M 10/0569

(52) U.S. Cl. CPC H01M 10/0568; H01M 10/0567; H01M 10/0569; H01M 2300/0037

(57) ABSTRACT

The present invention relates to an electrolyte composition for a lithium ion battery, the composition including:
(a) 7-36 wt % of lithium bis(fluorosulfonyl)imide;
(b) 0.6-6 wt % of further lithium salt(s), selected from one or more of lithium difluoro (oxalato) borate, lithium difluorophosphate, lithium bis(oxalato) borate and lithium hexafluorophosphate;
(c) 2-10 wt % of additive; wherein the additive comprises vinylene carbonate and/or fluoroethylene carbonate; and
(d) 50-85 wt % solvent; wherein the solvent comprises one or more of dimethyl carbonate, diethyl carbonate and ethyl methyl carbonate;

wherein all weight percentages are calculated relative to weight of the whole the electrolyte composition.

### TECHNICAL FIELD

The present invention relates to electrolyte compositions.

### BACKGROUND

Commercial lithium-ion batteries typically use LiPF₆ as the lithium salt source and a solvent including ethylene carbonate.

Ethylene carbonate has been an indispensable ingredient in electrolyte formulas since the invention of lithium ion battery. It is well known that ethylene carbonate is involved in passivation of the graphite anode; this results from a self-terminated reduction reaction of ethylene carbonate and other components at the graphite surface during the first charge-discharge cycle. The resulting ‘coating’ on the graphite surface is referred to as solid electrolyte interphase or SEI.

The SEI affects cell performance parameters such as first cycle efficiency, cycle life, self-discharging behaviour, high-temperature capacity loss, and rate performance.

### SUMMARY

The invention provides electrolyte compositions which do not require the presence of ethylene carbonate and use high lithium salt concentration.

According to a first aspect of the present invention, there is provided an electrolyte composition for a lithium ion battery, the composition including:
(a) 7-36 wt % of lithium bis(fluorosulfonyl)imide;
(b) 0.6-6 wt % of further lithium salt(s), selected from one or more of lithium difluoro (oxalato) borate, lithium difluorophosphate, lithium bis(oxalato) borate and lithium hexafluorophosphate;
(c) 2-10 wt % of additive; wherein the additive comprises vinylene carbonate and/or fluoroethylene carbonate;
(d) 50-85 wt % solvent; wherein the solvent comprises one or more of dimethyl carbonate, diethyl carbonate and ethyl methyl carbonate;
wherein all weight percentages are calculated relative to weight of the whole the electrolyte composition.

Without being bound by theory, it is thought that the improved rate performance is due to the combination of high lithium salt concentrations, the linear carbonate solvents and a highly conductive SEI. The electrolyte composition has been observed to passivate both artificial and natural graphite. In addition, the composition uses lithium bis(fluorosulfonyl)imide as the bulk electrolyte, and this has a higher ionic conductivity than LiPF₆ (the commonly used standard electrolyte).

Further, the inventors have observed that the claimed compositions provide an improved cell cycle life (which means less capacity decaying over cycling). In addition, through reducing or eliminating the LiPF₆ salt in this formulation, the tendency to release HF in cases of cell thermal runaway is reduced, and the composition is less moisture sensitive during cell manufacture.

The invention also provides a battery component comprising an electrolyte composition according to the first aspect.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1 shows the discharge capacity retention (compared to 0.2C discharge capacity) of a Swagelok cell with a mixed graphite/SiOx anode at 30° C. for an electrolyte composition according to the invention and comparative data for a prior art composition.

FIG. 2 shows the discharge capacity retention (compared to 0.2C discharge capacity) of a Swagelok cell with a graphite anode at 30° C. for electrolyte compositions according to the invention, and comparative data for a prior art electrolyte composition.

FIG. 3 shows the discharge capacity retention (compared to 0.2C discharge capacity) for a Swagelok cell with a graphite anode at 30° C. for electrolyte compositions according to the invention, comparative data for a prior art electrolyte composition and the % increase for the compositions according to the invention relative to the prior art composition.

FIG. 4 shows the long-term performance over many charging/discharging cycles at 45° C. in pouch cells with a graphite anode for a composition according to the invention and a prior art composition.

### DETAILED DESCRIPTION

In some cases, the lithium concentration in the composition is between about 0.8M and 2.8M. In some cases, the lithium concentration in the composition is between about 1.5M and 2.2M, suitably between 1.8M and 2.0M.

In some cases, the additive comprises vinylene carbonate and fluoroethylene carbonate. In some cases, the additive substantially consists of or consists of vinylene carbonate and fluoroethylene carbonate. In some cases, the weight ratio of vinylene carbonate and fluoroethylene carbonate is from about 1:2 to about 3:1, suitably about 2:1.

In some cases, the electrolyte composition includes about 5-8 wt % of additive, suitably about 6-7 wt % of additive.

In some cases, the composition includes 10-30 wt %, 15-30 wt % or 20-30 wt % of lithium bis(fluorosulfonyl)imide. In some cases, the composition includes 23-27 wt % of lithium bis(fluorosulfonyl)imide.

In some cases, the composition is substantially free from, or free from, LiPF₆. In some cases, the composition includes 2-3 wt % of the further lithium salt(s). In some such cases, the further lithium salt consists of lithium difluoro (oxalato) borate.

In some cases, the composition includes 60-70 wt % of solvent. In some cases, the solvent substantially consists of or consists of one or more of dimethyl carbonate, diethyl carbonate and ethyl methyl carbonate. In some such cases, the solvent includes two of ethyl methyl carbonate, diethyl carbonate and dimethyl carbonate, suitably at a weight ratio of about 1:1.

In some cases, the composition is substantially free from, or free from, ethylene carbonate.

In some cases, the composition consists of lithium bis(fluorosulfonyl)imide, lithium difluoro (oxalato) borate, vinylene carbonate, fluoroethylene carbonate and a solvent consisting of one or more of dimethyl carbonate, diethyl carbonate and ethyl methyl carbonate.

In some cases, the electrolyte composition is selected from the following:
(a) about 12.5 wt % lithium bis(fluorosulfonyl)imide, about 2.4 wt % lithium difluoro (oxalato) borate, about 4.6 wt % vinylene carbonate, about 2.3 wt % fluoroethylene carbonate, about 39.1 wt % of dimethyl carbonate, and 39.1 wt % of ethyl methyl carbonate.
(b) about 14.0 wt % lithium bis(fluorosulfonyl)imide, about 2.4 wt % lithium difluoro (oxalato) borate, about 4.4 wt % vinylene carbonate, about 2.2 wt % fluoroethylene carbonate, about 38.5 wt % of dimethyl carbonate, and 38.5 wt % of ethyl methyl carbonate.
(c) about 17.2 wt % lithium bis(fluorosulfonyl)imide, about 2.4 wt % lithium difluoro (oxalato) borate, about 4.2 wt % vinylene carbonate, about 2.2 wt % fluoroethylene carbonate, about 37.0 wt % of dimethyl carbonate, and 37.0 wt % of ethyl methyl carbonate.
(d) about 20.3 wt % lithium bis(fluorosulfonyl)imide, about 2.4 wt % lithium difluoro (oxalato) borate, about 4.1 wt % vinylene carbonate, about 2.1 wt % fluoroethylene carbonate, about 35.6 wt % of dimethyl carbonate, and 35.6 wt % of ethyl methyl carbonate.
(e) about 23.3 wt % lithium bis(fluorosulfonyl)imide, about 2.4 wt % lithium difluoro (oxalato) borate, about 4.0 wt % vinylene carbonate, about 2.0 wt % fluoroethylene carbonate, about 34.2 wt % of dimethyl carbonate, and 34.2 wt % of ethyl methyl carbonate.
(f) about 26.5 wt % lithium bis(fluorosulfonyl)imide, about 2.4 wt % lithium difluoro (oxalato) borate, about 3.8 wt % vinylene carbonate, about 1.9 wt % fluoroethylene carbonate, about 32.7 wt % of dimethyl carbonate, and 32.7 wt % of ethyl methyl carbonate.
(g) about 35.8 wt % lithium bis(fluorosulfonyl)imide, about 2.4 wt % lithium difluoro (oxalato) borate, about 3.3 wt % vinylene carbonate, about 1.7 wt % fluoroethylene carbonate, about 28.4 wt % of dimethyl carbonate, and 28.4 wt % of ethyl methyl carbonate.

In some cases, the electrolyte composition is composition (f). That is, in some cases, the electrolyte composition 26.5 wt % lithium bis(fluorosulfonyl)imide, about 2.4 wt % lithium difluoro (oxalato) borate, about 3.8 wt % vinylene carbonate, about 1.9 wt % fluoroethylene carbonate, about 32.7 wt % of dimethyl carbonate, and 32.7 wt % of ethyl methyl carbonate.

The comparative data used in this application (referred to as a “comparative example”, a “prior art composition”, a “state of the art composition” and the like) relates to the following electrolyte composition, which is known in the art: 13.4 wt % LiPF₆, 21.0 wt % ethylene carbonate, 63.1 wt % ethyl methyl carbonate, 2 wt % vinylene carbonate and 0.5 wt % fluoroethylene carbonate. This is to be a performance-leading prior art composition.

Through forming highly conductive SEI, coupled to the use of a lithium salt with higher ionic conductivity (lithium bis(fluorosulfonyl)imide) at high salt concentration, the overall internal resistance of the cell is significantly lowered (seen in impedance spectroscopy) and provides improved rate performance (e.g. at 3C-7C rates). This provides significantly longer runtime at high power modes.

Such electrolyte performance will permit design of high energy cells which can exhibit elevated power performance. Improved ion transport through the SEI and bulk electrolyte means that thicker electrodes with higher active material content can be used.

The electrolyte compositions (a) to (g) above were tested in cells, as described below, to determine the rate capacity and retention at various discharge rates, as illustrated in the figures.

Electrochemical evaluations of the electrolytes were carried out with Swagelok or pouch type cells. All the cells have one layer of cathode with areal coating weight over 150 g/m², which consists of over 90 wt % a high nickel NMC active materials and one layer of anode with areal coating weight over 100 g/m², which consists of over 90 wt % graphite/SiOx mixed active materials.

Cell assembly was carried out in a dry-room with Dew point less than −40° C. By design, the nominal capacity was about 3.5 mAh or 40.0 mAh for Swagelok or pouch type cells, respectively. The capacity balance was controlled at about 85-90% utilisation of the anode. For all the cells, glass fibre separators were used and 70 μl or 1 ml of an electrolyte was added for Swagelok or pouch cells, respectively.

All the cells were electrochemically formed at 30° C. A cell was initially charged with a current of C/20 (a current with which it takes 20 hours to fully charge or discharge the cell) for the first hour and then increased to C/10 for the rest of charging until the cell voltage reaching the cut-off voltage of 4.2V. Then the cell is discharged at C/10 until the cut-off voltage of 2.5V. The cell cycles two more cycles with the same cut-off voltages at C/10 for both charging and discharging. The first-cycle efficiency was determined by the first cycle charging capacity divided by first cycle discharging capacity and presented as percentage. Once a cell passed this formation step, rate capability was tested at 30° C. and 45° C., sequentially. The C-rates were calculated based on cathode nominal capacity (active material weight times its theoretical capacity). In a rate capability test, all the charging was carried out at current of C/5 while the discharging ranging from C/10 to 10C. The rate capacities were thus determined, which can be further normalised by dividing the C/5 capacity from the same test.

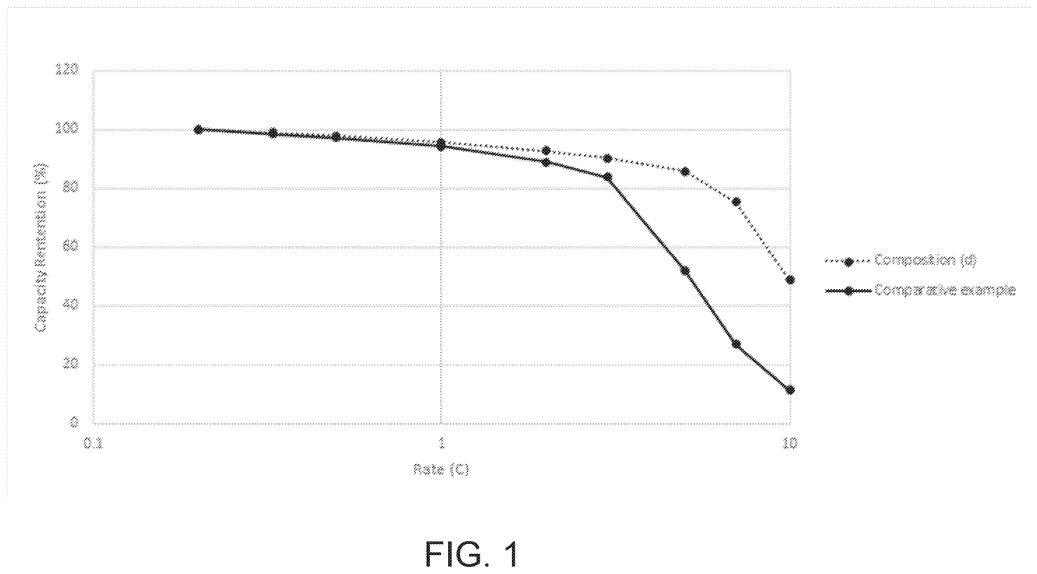

It can be seen from FIG. 1 that composition (d) provides improved capacity retention at high C-rates as compared to the state-of-the-art prior art composition, and has equivalent performance up to about 1C.

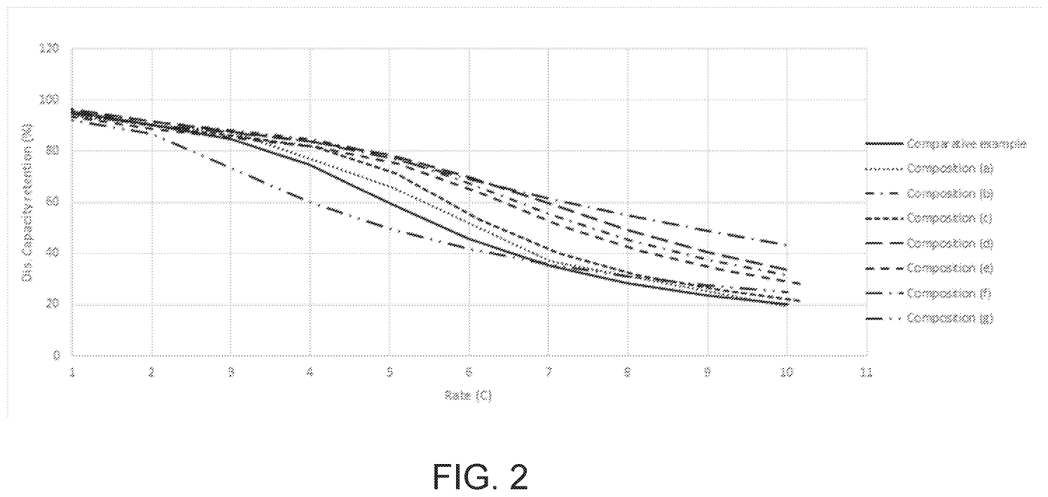

It can be seen from FIG. 2 that compositions (a) to (f) have improved discharge rate retention at 3C and above as compared to the state-of-the-art prior art composition, comparable performance for 1C-2C, and that composition (g) has improved discharge rate retention at 7C and above.

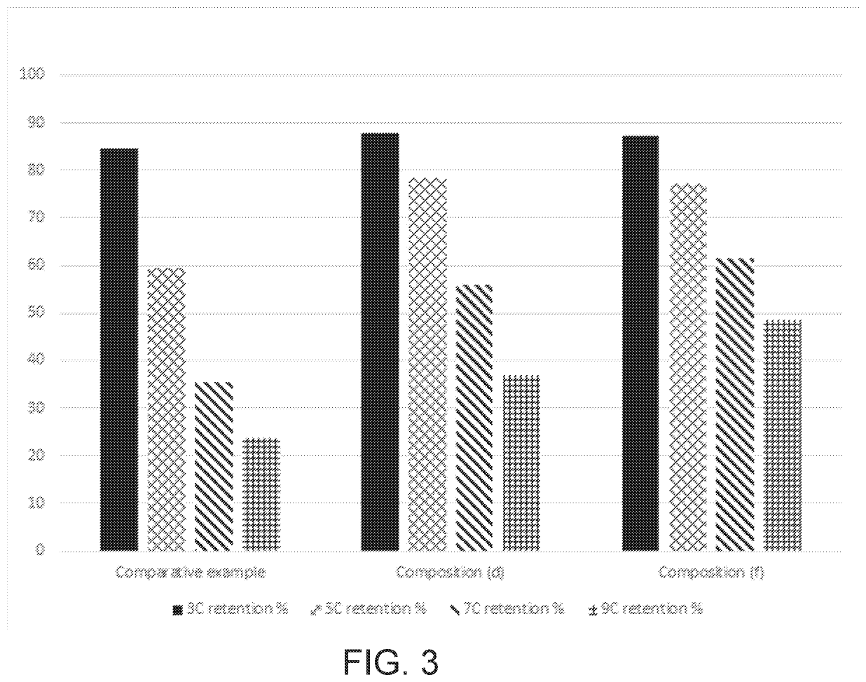

FIG. 3 quantifies the improvement in rate retention for compositions (d) and (f) as compared to the state-of-the-art prior art composition at 3C, 5C, 7C and 9C.

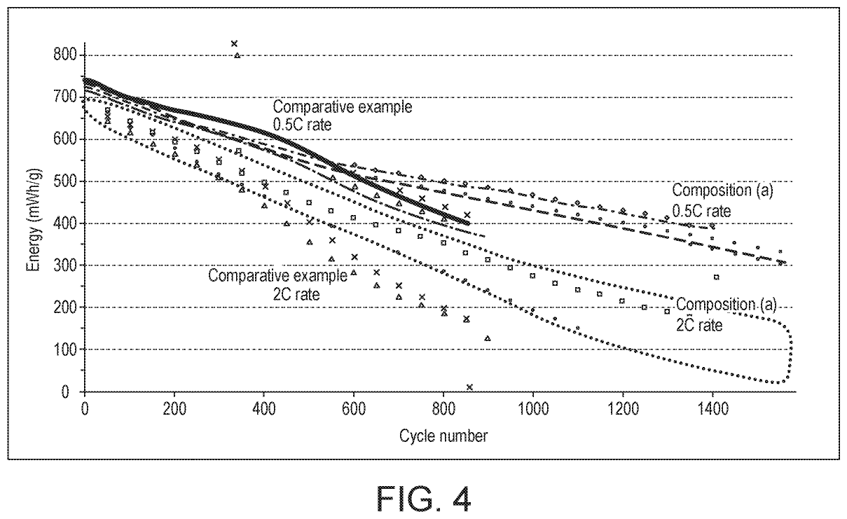

FIG. 4 shows that composition (d) provides improved long-term performance over large cycle numbers at both 2C and 0.5C discharge rates. The energy retention for the cell is higher in both circumstances for composition (d) as compared to the state-of-the-art prior art composition.

As used herein, the term “comprising”, “comprises” or the like is an open term, meaning including the subsequent integers and optionally other, non-recited features. The term “consisting of” and the like means that the embodiment includes only the subsequently listed integers. Where embodiments are discussed herein and use the term “comprises” or the like, we hereby explicitly disclose corresponding embodiments using the term “consists”. The term “substantially consists of” means that the embodiment includes only the subsequently listed integers, but permits inconsequential amounts of non-listed features (e.g. impurities in a composition). In instances where this term relates to a composition, the term “substantially consists of” may, for example, be taken to mean that at least 98% or 99% by weight of the overall composition is made up of the subsequently listed integers.

The above embodiments are to be understood as illustrative examples of the invention. Further embodiments of the invention are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. An electrolyte composition for a lithium ion battery, the composition including:
(a) 7-36 wt % of lithium bis(fluorosulfonyl)imide;
(b) 0.6-6 wt % of one or more further lithium salt(s) selected from the group consisting of lithium difluoro (oxalato) borate, lithium difluorophosphate, lithium bis(oxalato) borate and lithium hexafluorophosphate;
(c) 2-10 wt % of an additive; wherein the additive comprises vinylene carbonate and/or fluoroethylene carbonate; and
(d) 50-85 wt % of a solvent; wherein the solvent comprises one or more of dimethyl carbonate, diethyl carbonate and ethyl methyl carbonate;
wherein all weight percentages are calculated relative to weight of the whole the electrolyte composition.

2. An electrolyte composition according to claim 1, wherein the lithium concentration in the composition is between about 0.8M and 2.8M.

3. An electrolyte composition according to claim 1, wherein the additive comprises vinylene carbonate and fluoroethylene carbonate.

4. An electrolyte composition according to claim 3, wherein a weight ratio of vinylene carbonate and fluoroethylene carbonate is from about 1:2 to about 3:1.

5. An electrolyte composition according to claim 1, wherein the composition includes about 6-7 wt % of the additive.

6. An electrolyte composition according to claim 1, wherein the composition includes 20-30 wt % of lithium bis(fluorosulfonyl)imide.

7. An electrolyte composition according to claim 1, wherein the composition includes 2-3 wt % of the one or more further lithium salt(s).

8. An electrolyte composition according to claim 1, wherein the further lithium salt consists of lithium difluoro (oxalato) borate.

9. An electrolyte composition according to claim 1, wherein the composition includes 60-70 wt % of solvent.

10. An electrolyte composition according to claim 1, wherein the solvent includes two of ethyl methyl carbonate, diethyl carbonate and dimethyl carbonate.

11. An electrolyte composition according to claim 1, wherein the composition is substantially free from ethylene carbonate.

12. An electrolyte composition according to claim 1, wherein the composition consists of lithium bis(fluorosulfonyl)imide, lithium difluoro (oxalato) borate, vinylene carbonate, fluoroethylene carbonate and a solvent consisting of one or more of dimethyl carbonate, diethyl carbonate and ethyl methyl carbonate.

13. An electrolyte composition according to claim 1, wherein the composition consists of about 26.5 wt % lithium bis(fluorosulfonyl)imide, about 2.4 wt % lithium difluoro (oxalato) borate, about 3.8 wt % vinylene carbonate, about 1.9 wt % fluoroethylene carbonate, about 32.7 wt % of dimethyl carbonate, and 32.7 wt % of ethyl methyl carbonate.

14. A battery component comprising an electrolyte composition according to claim 1.
